(19) United States
(12) Patent Application Publication
(10) Pub. No.: US 2010/0082292 A1
(43) Pub. Date: Apr. 1, 2010

(54) ANALYTICAL GENERATOR OF KEY PERFORMANCE INDICATORS FOR PIVOTING ON METRICS FOR COMPREHENSIVE VISUALIZATIONS

(75) Inventors: Michael John Pantaleano, Willoughby, OH (US); Bruce Gordon Fuller, Edmonton (CA); Robert Joseph McGreevy, Oswego, IL (US); Ian Edward Tooke, Innisfil (CA); Kevin John Albert, Wauwatosa, WI (US); John Joseph Baier, Mentor, OH (US); Jan Pingel, New Berlin, WI (US)

Correspondence Address: ROCKWELL AUTOMATION;for Turocy & Watson LLP, 1201 SOUTH SECOND STREET, E-7F19, MILWAUKEE, WI, 53204, US

(73) Assignee: ROCKWELL AUTOMATION TECHNOLOGIES, INC., Mayfield Heights, OH (US)

(21) Appl. No.: 12/242,122

(22) Filed: Sep. 30, 2008

(51) Int. Cl. G21C 17/00; G06F 3/048; G05B 15/02

(52) U.S. Cl. 702/182; 715/771; 700/83

(57) ABSTRACT

A process context analyzer of an industrial process allows the flexibility of a client to customize process data that is captured, which can allow data capture to encompass a larger hierarchy of an enterprise or lower subset of a hierarchy with a requisite need for customization to match its architecture. Although analytics can be readily accessed for fixed context for which key performance indicators (KPIs) visualizations are defined, an opportunity for addressing abnormal operation or non-optimal performance is addressed by brining enhanced analytics that benefit from recognizing attributes of the flexible context. Thereby, requested calculated tags can be supplied, as well as offering a return on investment increase by pattern recognition of time frame dependent or ambient condition dependent variations in the flexible context.

### TECHNICAL FIELD

The subject invention relates generally to industrial control systems, and more particularly to visualization and analytical systems that interact with industrial control systems based in part on collecting and archiving process data of production and operational problems.

### BACKGROUND

Industrial controllers are special-purpose computers utilized for controlling industrial processes, manufacturing equipment, and other factory automation, such as data collection or networked systems. One type of industrial controller at the core of an industrial control system is a logic processor such as a programmable logic controller (PLC) or personal computer (PC) based controller. Programmable logic controllers for instance, are programmed by systems designers to operate manufacturing processes via user-designed logic programs or user programs. The user programs are stored in memory and generally executed by the PLC in a sequential manner although instruction jumping, looping and interrupt routines, for example, are also common. Associated with the user program are a plurality of memory elements or variables that provide dynamics to PLC operations and programs.

Connected to the PLC are input/output (I/O) devices. I/O devices provide connection to the PLC for both automated data collection devices such as limit switches, photoeyes, load cells, thermocouples, etc. and manual data collection devices such as keypads, keyboards, pushbuttons, etc. Differences in PLCs are typically dependent on number of I/O they can process, amount of memory, number and type instructions and speed of the PLC central processing unit (CPU).

Another type of industrial controller at the core of an industrial control system is the process controller of a distributed control system (DCS). The process controller is typically programmed by a control engineer for continuous process control such as an oil refinery or a bulk chemical manufacturing plant. A control engineer typically configures control elements such as proportional-integral-derivative (PID) control loops to continuously sample the I/O data, known as the process variable, from the process, compare the process variable to a configured set point and output an error signal, proportional to the difference between the set point and the process variable, to the control device. The control device then adjusts the element controlling the process property, such as a valve in a pipe for flow control or a heating element in a distillation column for temperature control, in an attempt to minimize the error signal. As the DCS name implies, many process controllers are distributed around the process and are communicatively coupled to each other forming the overall control system.

Connected to the process controller are similar types of I/O devices as connected to the PLC and additionally, intelligent I/O devices more common to the process control industry. These intelligent devices have embedded processors capable of performing further calculations or linearization of the I/O data before transmission to the process controller.

A visualization system is generally connected to the industrial controller to provide a human-friendly view into the process instrumented for monitoring or control. The user of a visualization system configures one or more graphical displays representing some aspect of the process the industrial controller is controlling or monitoring. The graphical displays each contain a user configured number of data values collected from the I/O connected to the industrial controller and considered by the user as relevant to the particular graphical display or process area of interest. Other data points may be configured strictly for archival purposes or to generate reports related to interests such as production, downtime, operator efficiency, raw material usage, etc.

Automating control and human-machine interface (HMI) to achieve efficiency, quality, safety, performance, etc. generally requires expertise to be embodied in a model. Relationships between certain data parameters are determined in order to prompt an operator or to facilitate automatic control events. Often such models benefit from tendencies for setting up identical processing lines (e.g., batch, continuous, or discrete). Thus, the investment in such models can be realized across sites of an enterprise.

However, generally such models, if in existence at all, tend to be an incomplete solution. Production lines can be customized for particular applications. Substituted hardware can perform similarly, but not identically, to that which was modeled. Ambient parameters (e.g., humidity, temperature, etc.) can vary from location to location and from time to time within a facility. Materials input into a process can vary from batch to batch or from different suppliers. Further, relationships between certain parameters can go unappreciated during the development of a process model. Although increasingly data is available from ubiquitous integrated devices and sensors, the large amount of data does not necessarily enhance understanding of why an industrial process is departing from a desired optimum condition.

### SUMMARY

The following presents a simplified summary in order to provide a basic understanding of some aspects described herein. This summary is neither an extensive overview nor is intended to identify key/critical elements or to delineate the scope of the various aspects described herein. Its sole purpose is to present some concepts in a simplified form as a prelude to the more detailed description presented later.

A dynamic context analyzer enables a client to customize data capture to include flexible context in addition to fixed context that supports recognized key performance indicators (KPIs) for established visualizations. Enhanced analytics dynamically responds to a client's desire to analyze the fixed and flexible content in order to recognize associations within the context that affect normal or optimal performance.

In one aspect, a method generates dynamic context for an industrial process. Context data from an industrial process is captured. A request to perform a calculated value for the captured context data is received. A context attribute is recognized by accessing a process category associated with the industrial process. The calculated value is generated based upon the recognized context attribute.

In another aspect, at least one processor generates dynamic context for an industrial process. A first module accesses context data from an industrial process. A second module generates a key performance indicator visualization for a subset of fixed context data of the accessed context data. A third module receives a request for a calculated tag based on a subset of flexible context data of the accessed context data. A fourth module generates the requested calculated tag.

In an additional aspect, an apparatus generates dynamic context for an industrial process. A data capture component captures context data from an industrial process. A human-machine interface (HMI) receives a request to perform a calculated value for the captured context data. A dynamic context analyzer recognizes a context attribute by accessing a process category associated with the industrial process, and generates the calculated value based upon the recognized context attribute.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of a dynamic context system for an industrial process;

FIG. 2 illustrates a flow diagram of a methodology for dynamically weighing context attributes to converge on relevant context facilitating automated decision making;

FIG. 3 illustrates a block diagram of a dynamic context system that interacts with an industrial process of an enterprise industrial process;

FIG. 4 illustrates a block of a computing platform for the dynamic context system of FIG. 3;

FIG. 5 illustrates a flow diagram of a distributed methodology for dynamically weighing context attributes to converge on relevant context facilitating automated decision making

FIG. 6 illustrates a block diagram of an enterprise industrial process hierarchy;

FIG. 7 illustrates a block diagram of a functional module for performing at least a part of a KPI guidance system for comprehensive visualizations;

FIG. 8 illustrates an aspect of the visualization system depicting a typical computing environment; and

FIG. 9 illustrates an aspect of the visualization system depicting the interaction between KPI clients and KPI servers.

### DETAILED DESCRIPTION

A process context analyzer of an industrial process allows the flexibility of a client to customize process data that is captured, which can allow data capture to encompass a larger hierarchy of an enterprise or lower subset of a hierarchy with a requisite need for customization to match its architecture. Although analytics can be readily accessed for fixed context for which key performance indicators (KPIs) visualizations are defined, an opportunity for addressing abnormal operation or non-optimal performance is addressed by brining enhanced analytics that benefit from recognizing attributes of the flexible context. Thereby, requested calculated tags can be supplied, as well as offering a return on investment increase by pattern recognition of time frame dependent or ambient condition dependent variations in the flexible context.

It is noted that as used in this application, terms such as “component,” “display,” “interface,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith. Additionally, it is noted that as used in this application, terms such as “system user,” “user,” “operator” and the like are intended to refer to the person operating the computer-related entity referenced above.

As used herein, the term to “infer” or “inference” refer generally to the process of reasoning about or inferring states of the system, environment, user, and/or intent from a set of observations as captured via events and/or data. Captured data and events can include user data, device data, environment data, data from sensors, sensor data, application data, implicit and explicit data, etc. Inference can be employed to identify a specific context or action, or can generate a probability distribution over states, for example. The inference can be probabilistic, that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It is also noted that the interfaces described herein can include a Graphical User Interface (GUI) to interact with the various components for providing industrial control information to users. This can include substantially any type of application that sends, retrieves, processes, and/or manipulates factory input data, receives, displays, formats, and/or communicates output data, and/or facilitates operation of the enterprise. For example, such interfaces can also be associated with an engine, editor tool or web browser although other type applications can be utilized. The GUI can include a display having one or more display objects (not shown) including such aspects as configurable icons, buttons, sliders, input boxes, selection options, menus, tabs and so forth having multiple configurable dimensions, shapes, colors, text, data and sounds to facilitate operations with the interfaces. In addition, the GUI can also include a plurality of other inputs or controls for adjusting and configuring one or more aspects. This can include receiving user commands from a mouse, keyboard, speech input, web site, remote web service and/or other device such as a camera or video input to affect or modify operations of the GUI.

Additionally, it is also noted that the term industrial controller as used herein includes both PLCs and process controllers from distributed control systems and can include functionality that can be shared across multiple components, systems, and or networks. One or more industrial controllers can communicate and cooperate with various network devices across a network. This can include substantially any type of control, communications module, computer, I/O device, Human Machine Interface (HMI)) that communicate via the network which includes control, automation, and/or public networks. The industrial controller can also communicate to and control various other devices such as Input/Output modules including Analog, Digital, Programmed/Intelligent I/O modules, other programmable controllers, communications modules, and the like. The network (not shown) can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

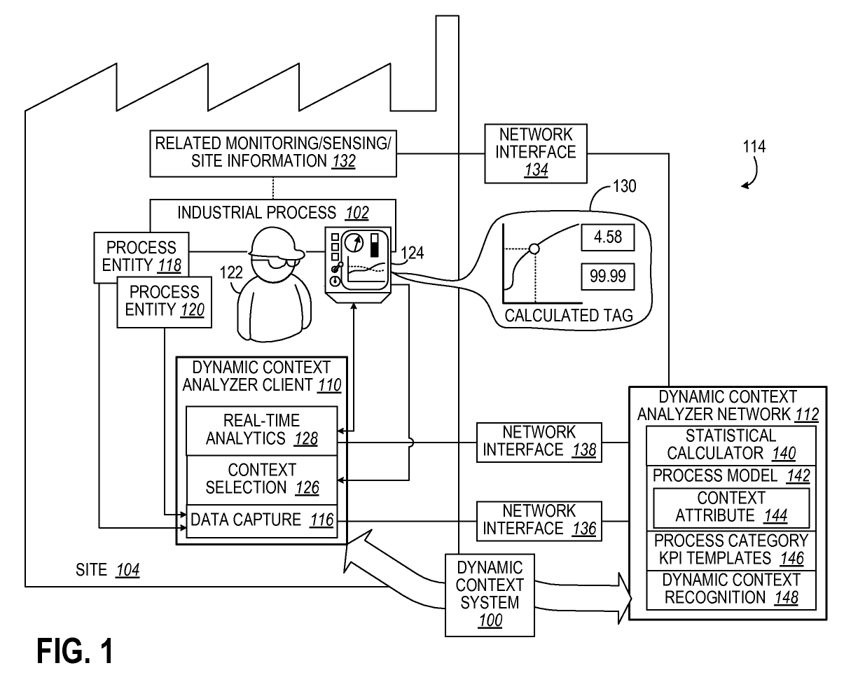

Referring initially to FIG. 1, a dynamic context system 100 for an industrial process 102 enables a particular industrial subset, depicted as an industrial site 104, to define flexible context for data capture that departs from fixed context data capture for which existing analytical visualizations of key performance indicators (KPIs) exist. The dynamic context system 100 advantageously embodies sufficient knowledge of comparable industrial processes in order to categorize the flexible context and to thus dynamically calculate tags as requested in order to support process optimization/correction decision making.

In an exemplary aspect, the dynamic context system 100 is distributed into a dynamic context analyzer (DCA) client 110 and a remote dynamic context analyzer 112 that comprise a dynamic context analysis network 114. The DCA client 110 can integrate and synchronize process data in a data capture component 116 from a plurality of process entities 118, 120 (e.g., embedded historian, manufacturing execution system (MES), production center server, ambient condition sensor, etc.) at the industrial site 104. An operator 122 can interact with a human machine interface (HMI) 124 in order to making context selections with a context selection component 126 of the client 110, such as displaying tabulated, raw data of flexible context. The operator 122 can also input certain configuration settings to provide approximate understanding of how the flexible context relates to the industrial process 102. The operator 122 can also interact with the HMI 124 to utilize a real-time analytics component 128 of the client 110 to retroactively process the captured data to provide calculated tags and visualization 130 beyond a standard suite of KPI visualizations/calculations for the fixed context data.

Advantageously, the remote DCA 112 can benefit from securely and confidentially receiving context data from a plurality of industrial sites 104, by having expanded industrial modeling expertise than available at an individual client 110 or having access to related monitoring/sensing/site information than what is available at the client 110. In an exemplary aspect, the dynamic context system 100 incorporates a plurality of network interfaces in order to communicate with a range of disparate types of industrial process entities 118, 120 and industrial sites 104. For instance, a related monitor component, sensing component or site information component 132 associated with the industrial process 102 can provide via a network interface 134 ambient condition data (e.g., humidity, temperature, vibration, barometric pressure, etc.), personnel data (e.g., de-personalized) for operators, layout dimensions (e.g., length of conveyor), and input material characteristic or identifier, etc. Captured data can pass via a network interface 136 and real-time analytics subscription information can pass via a network interface 138.

The remote DCA 112 can comprise a statistical calculator 140 than can perform calculations on data received or enable statistical calculations by the client 110. A process model 142 can provide an inferential engine for understanding flexible context data or can interface with site information in order to understand a custom or standard industrial architecture. Thereby, context attribute reference 144 can draw upon this information or inference in order to interpret flexible context data for calculating tags and for pattern recognition of abnormal or non-optimal performance. A process category KPI template component 146 can support conventional analytics for fixed context that comports to standard formats or can provide templates that can be adapted to visualize flexible context. A dynamic context recognition component 148 can manage pattern recognition of the interpreted flexible context and fixed context received from data capture, such as recognizing variances in certain parameters that correspond to ambient, personnel or time frames.

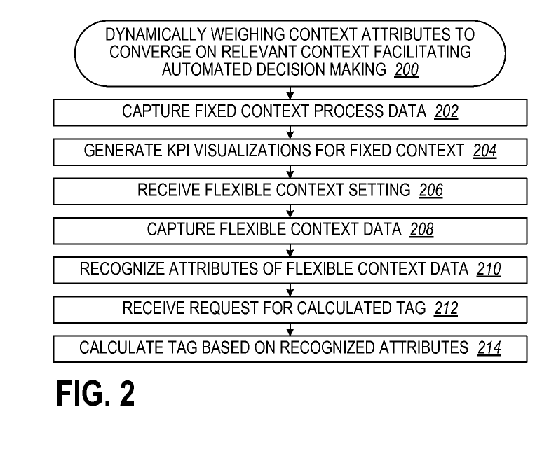

Turning to FIG. 2, a methodology 200 is depicted for dynamically weighing context attributes to converge on relevant context facilitating automated decision making. In block 202, fixed context process data is captured that comports to standardized formats for KPI visualizations and HMI alerts/controls, etc. In block 204, KPI visualizations for the fixed context are generated as requested or as configured. In block 206, flexible context settings are received, allowing a client to adapt monitoring and reporting for an industrial process to customizations and preferences. In block 208, flexible context data is captured in accordance to the flexible context setting. In block 210, attributes of flexible context data is recognized, such as by knowing an overall category for a process entity that provides the flexible context data or other inferential means. In block 212, a request is received for a calculated tag based on the flexible context. In block 214, the tag is calculated based upon the recognized attributes. For example, analytics for statistical analysis based upon time frames are enhanced by the system tracking a sample rate. As another example, the analytics can infer what type of equipment is producing data and thus interpret an attribute as to unit of measure corresponding to data values. As an additional example, the analytics can combine a process architecture either provided or inferred in order to associate captured data with a KPI that depends upon that input.

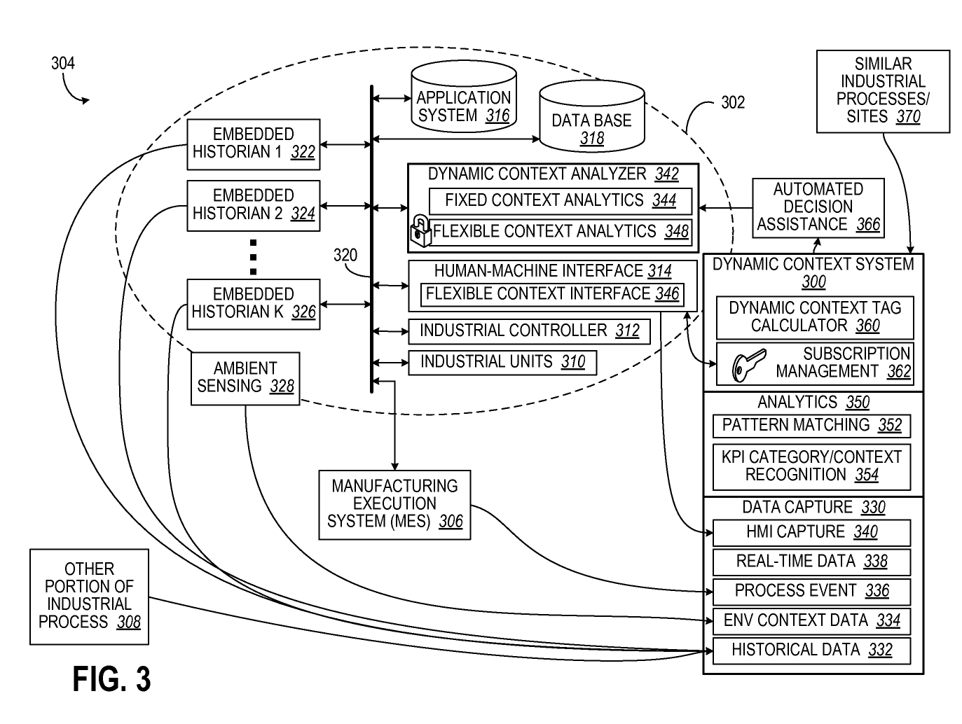

In FIG. 3, a dynamic context system 300 can interact with an industrial process 302 of an enterprise industrial process 304, as well as a manufacturing execution system 306 and other portions 308 of the enterprise industrial process 304. The industrial process is depicted as industrial units 310, industrial controller 312, HMI 314, application system storage 316, and data base 318 on a network bus 320. A plurality of embedded historians 322, 324, 326 reside on the network bus 320 or communicate with one or more of the other components of the industrial process 304 to capture process data. An ambient sensing component 328 can advantageously expand upon data regarding characteristics of the industrial process, such as by sensing humidity, vibration levels, temperature, barometric pressure, etc.

A data capture component 330 of the dynamic context system 300, or an independent system upon which the dynamic context system 300 provides additional functionality, has a historical data capture component 332 that receives historical process data from the historians 322-326 and data from other portions 308. An environmental context data component 334 captures the ambient conditions. The data capture component 330 can further be receiving process information at a process data component 336 from a production center, such as via the manufacturing execution system (ME) 306, such as identifying a type of input material, process event data, personnel/shift identifiers, time synchronization information, etc. The data capture component 330 can comprise a real-time data process data component 338 that receives process data, such as by communicating with network bus 320. An HMI/video capture component 340 can be interfaced to the HMI 314.

The industrial process 302 can access a dynamic context analyzer 342 that enhances an automated or manual decision process by providing real-time analytics, such as a fixed context analytics component for fixed context data capture that conforms to standards for KPI visualization. Advantageously, the HMI 314 can provide interactivity for a flexible context interface 346 that allows an operator to define or access flexible context that is being captured specific to the industrial process 302. In accordance with a standard functionality, this flexible context interface 346 can support tabulated or other non-calculated displays or rendering of this flexible context.

Advantageously, a flexible context analytics component 348 of the dynamic context analyzer 342 can support a broader array of calculation options and pattern recognition that adapt to available data beyond fixed context to encompass flexible context. In particular, the dynamic context analyzer 300 can comprise an analytics component 350, which can otherwise be an independent system upon which the DCA 300 provides additional functionality, can comprise a KPI pattern matching component 352 that correlates flexible context data to time frames, ambient conditions, or to fixed context data, to determine patterns that can inform automated decision making. Such pattern matching can be real-time or historical. A KPI category/context recognition component 354 assists in pattern recognition or enabling tag calculations by integrating or inferring information about the industrial process 302 so that flexible context is understood.

The dynamic context system 300 advantageously has a dynamic tag calculator 360 that can perform on-the-fly calculations for the dynamic context analyzer 342, such as serving as a high performance computing platform for processing a large volume of captured data or having sufficient access to a range of distributed data storage. Alternatively, a subscription management component 362 can enable dynamic context tag calculator functionality within the flexible context analytics component 348 to perform such calculations. The subscription management component 362 can also offer unsolicited opportunities for improvement to return on investment by identifying abnormal or non-optimal conditions detected by the pattern matching component 352. These analytics thus can inform an automated decision assistance component 366 that can be offered to a client to enhance their industrial process 302. In particular, the dynamic context system 300 can provide dynamic context assistance to, or at least gain comparison information from, similar industrial processes or sites 370 for comparison purposes to the industrial process 302.

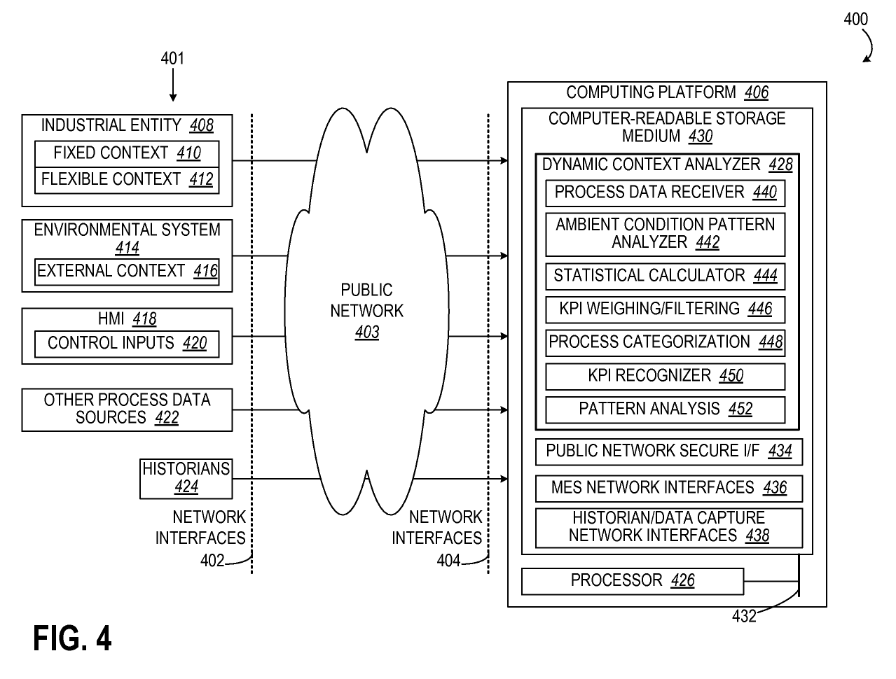

In FIG. 4, a dynamic context system 400 can advantageously comprise a distributed architecture of enterprise components 401 interfaced across one or more near network interfaces 402 across a public network (e.g., VPN, Internet) 403 across one or more far network interfaces 402, 404 to a computer platform 406. With regard to the enterprise components 401, an industrial entity (e.g., industrial controller, program control center, etc.) 408 can provided fixed content data provider 410 (e.g., KPIs defined for a category of industrial process recognized and standardized for visualization and control). The industrial entity 408 can also provide flexible context data provider 412 that allows the implementer of the industrial process to select other data parameters that can be learned as having bearing on normal or optimized control of the industrial process. An environmental system 414 has an external context component 416 that can be correlated with fixed and flexible context 410, 412. An HMI 418 provides visualizations and control inputs 420 that also be correlated. Other process components 422 can further provide context that can be correlated to find patterns. Historians 424 can also provide historical process data that can be merged into a data capture context.

The computing platform 406 has one or more processors 426 that execute dynamic context analyzer modules 428 accessed on a computer-readable storage medium 430 via an internal bus 432. These module 428 interact with the enterprise components 401 via HMI network interfaces 434, MES network interfaces 436, and historian/data capture network interfaces 438 residence in the storage medium (memory) 430. Exemplary modules 428 comprise a process data receiver 440, ambient condition pattern analyzer 442, statistical calculator 444, KPI weighing/filtering 446, process categorization 448, KPI recognizer 450, and pattern analysis 452.

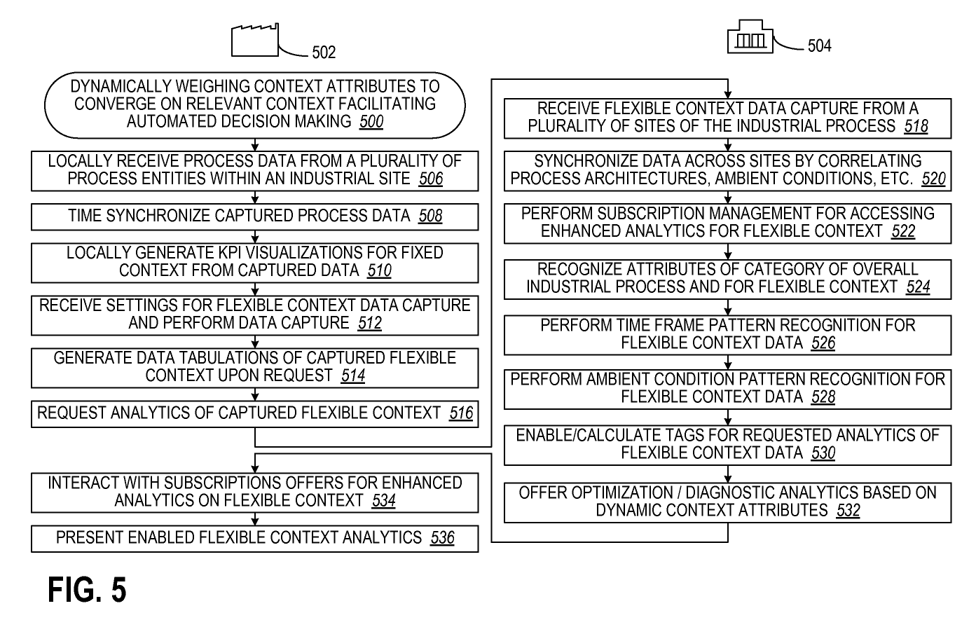

With reference to FIG. 5, a methodology 500 is depicted for dynamically weighing context attributes to converge on relevant context facilitating automated decision making. In an exemplary depiction for clarity, certain functions are performed at an industrial site 502 with others performed at a remote central location 504. It should be appreciated that all or a different subset of functions can be performed locally or remotely or that other distributions of data capture, analysis, reporting and implementation can be used consistent with aspects herein.

Beginning with the industrial site 502 in block 506, process data is locally received from a plurality of process entities within an industrial site. The captured process data is time synchronized for successful correlation (block 508). KPI visualizations are locally generated for fixed context derived from the captured data (block 510). Settings for flexible context data capture are received (block 512). In response, the data is capture. In block 514, data tabulations or other raw data renderings can be generated based on the captured flexible context upon request. In order to optimize the industrial process or to diagnose a problem, a request can be received in block 516 for enhanced analytics to include the flexible context data.

In the illustrative depiction, the remote central location 504 has been or continues to receive flexible context data captured from a plurality of sites of the identical or similar industrial process (block 518). As a value added service, in block 520 data across sites can be synchronized by correlating process architectures, ambient conditions, etc. In response to the specific request for enhanced analytics, in block 522 subscription management actions can be performed for accessing these functions for flexible context. Attributes of the flexible context can be recognized based upon information provided by the client, by recognizing a category of industrial process, by recognizing a format of the data as characteristic of a particular type of equipment, or by recognizing units of measure, etc. (block 524). An example of enhanced analytics is performing time frame pattern recognition for flexible context data (block 526). For example, a process can regularly vary based on what operators are on duty, what shift is on duty, what day of the week it is. Alternatively, a one-time occurrence can be correlated by capturing event data. For example, a change in input materials occurred suspiciously close to the change in a measured process parameter. As another example, an equipment change can be correlated with a change in performance. As another example of enhanced analytics, in block 528 pattern recognition for changes in performance as a function of ambient conditions is performed. For example, a particular production line can have performance that varies according to weather (e.g., temperature, humidity, barometric pressure, etc.). Alternatively, two production lines having different ambient conditions can be compared to determine an unappreciated sensitivity to an ambient condition.

Alternatively or in addition, the enhanced analytics can comprise enabling or performing calculations for tags based on the flexible context data, such as performing certain summations or statistical calculations (block 530). Those additional calculations done without request that show a likelihood of return on investment due to optimization or diagnostic analytics can be offered for a fee (block 532). Returning to the industrial site 502, subscription offers for enhanced analytic services can be accepted (block 534) and the requested or offered enhanced analytical services can be presented for consumption (block 536).

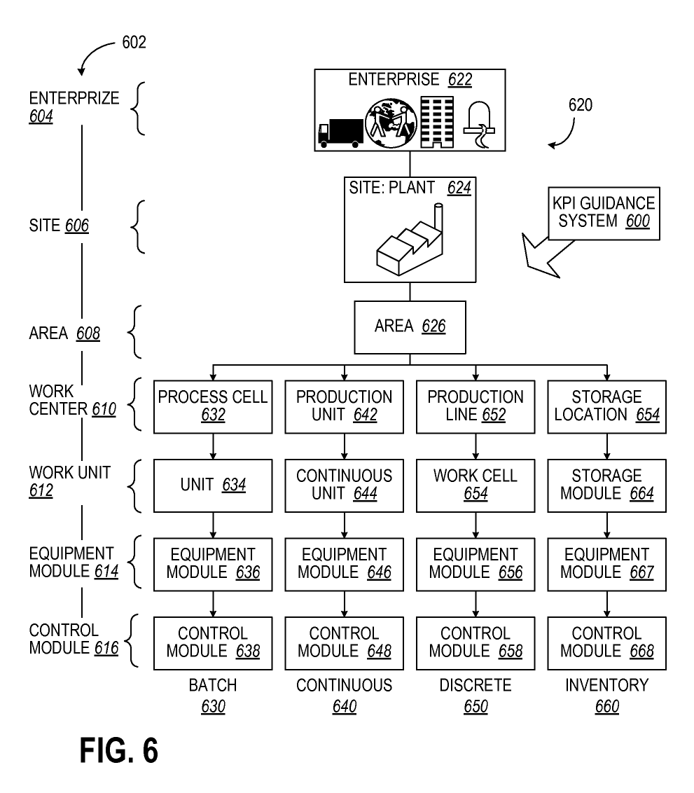

With reference to FIG. 6, a KPI guidance system 600 can span an industrial process having a distributed and hierarchical structure. Hierarchical representations that can be employed in connection with a schema employed by programmable logic controllers to facilitate use of a hierarchically structured data model are illustrated. The hierarchies illustrated in this figure relate to equipment hierarchies, which can be integrated with procedure hierarchies to generate a robust representation of a plant (which is incorporated within a schema for use in connection with industrial controllers). A general hierarchy 602 entails an enterprise level 604, a site level 606, an area level 608, a work center level 610, a work unit level 612, an equipment module level 614, and a control module level 616. In an illustrative aspect, an industrial process 620 has an enterprise level 622, a site level 624, and an area level 626 that further breaks down into four disparate types of sub-hierarchies. For instance, a first hierarchy 630 in accordance with a batch process can further include a representation of a process cell 632, unit 634, equipment module 636, and control module 638. In contrast, a hierarchical representation 640 of equipment within a continuous process can include representations of a production unit 642, continuous unit 644, equipment module 646, and control module 648. A third hierarchy 650 of equipment in accordance with a discrete system can further include a representation of a production line 652, a work cell 654, equipment module 656, and control module 658. A fourth hierarchy 660 of equipment in accordance with an inventory process can further include a storage location 662, storage module 664, equipment module 667, and control module 668.

For example, the enterprise 622 can represent an entirety of a company, the site 624 can represent a particular plant, an area can represent a portion of the plant, the process cell 632 can include equipment utilized to complete a process, a unit 634 can relate to a unit of machinery within the process cell 632, an equipment module 636 can include a logical representation of portions of the process cell 632, and the control module 638 can include basic elements, such as motors, valves, and the like. Furthermore, equipment modules 636 can include equipment modules and control modules can include control modules. Thus, as can be discerned from the figure, four disparate hierarchical representations can be employed to represent equipment within batch processes, continuous processes, discrete processes, and inventory.

For purposes of consistent terminology, data objects can be associated with metadata indicating which type of process they are associated with. Therefore, data objects can be provided to an operator in a form that is consistent with normal usage within such process. For example, batch operators can utilize different terminology than a continuous process operator (as shown by the hierarchy 650). Metadata can be employed to enable display of such data in accordance with known, conventional usage of such data. Thus, implementation of a schema in accordance with the hierarchy 620 will be seamless to operators. Furthermore, in another example, only a portion of such representation can be utilized in a schema that is utilized by a controller. For instance, it may be desirable to house equipment modules and control modules within a controller. In another example, it may be desirable to include data objects representative of work centers and work units within a controller (but not equipment modules or control modules). The claimed subject matter is intended to encompass all such deviations of utilizing the hierarchy 620 (or similar hierarchy) within a controller.

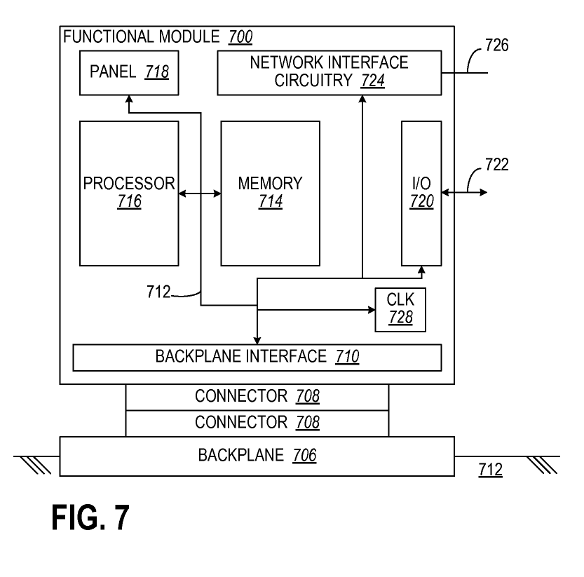

FIG. 7 illustrates an exemplary environment, depicted as a functional model 700, that can perform data capture, network interface, KPI guidance processing, or HMI visualization in accordance with various aspects of the subject innovation. Each functional module 700 is attached to a backplane 704 of an industrial process system 706 by means of a separable electrical connector 708 that permits the removal of the module 700 from the backplane 704 so that it may be replaced or repaired without disturbing the other modules 700. The backplane 704 provides the module 700 with both power and a communication channel to the other modules 700. Local communication with the other modules 700 through the backplane 704 is accomplished by means of a backplane interface 710 which electrically connects the backplane 704 through connector 708. The backplane interface 710 monitors messages on the backplane 704 to identify those messages intended for the particular module 700, based on a message address being part of the message and indicating the message destination. Messages received by the backplane interface 710 are conveyed to an internal bus 712 in the module 700.

The internal bus 712 joins the backplane interface 710 with a memory 714, a microprocessor 716, front panel circuitry 718, I/O interface circuitry 720 to industrial controller 722 and communication network interface circuitry 724 to an industrial network 726. The microprocessor 716 can be a general purpose microprocessor providing for the sequential execution of instructions included within the memory 714 and the reading and writing of data to and from the memory 714 and the other devices associated with the internal bus 712. The microprocessor 716 includes an internal clock circuit (not shown) providing the timing of the microprocessor 716 but may also communicate with an external clock 728 of improved precision. This clock 728 may be a crystal controlled oscillator or other time standard including a radio link to an external time standard. The precision of the clock 728 may be recorded in the memory 714 as a quality factor. The panel circuitry 718 includes status indication lights such as are well known in the art and manually operable switches such as for locking the module 700 in the off state.

The memory 714 can comprise control programs or routines executed by the microprocessor 716 to provide control functions, as well as variables and data necessary for the execution of those programs or routines. For I/O modules, the memory 714 may also include an I/O table holding the current state of inputs and outputs received from and transmitted to the industrial controller 710 via the I/O modules 720. The module 700 can be adapted to perform the various methodologies of the innovation, via hardware configuration techniques and/or by software programming techniques.

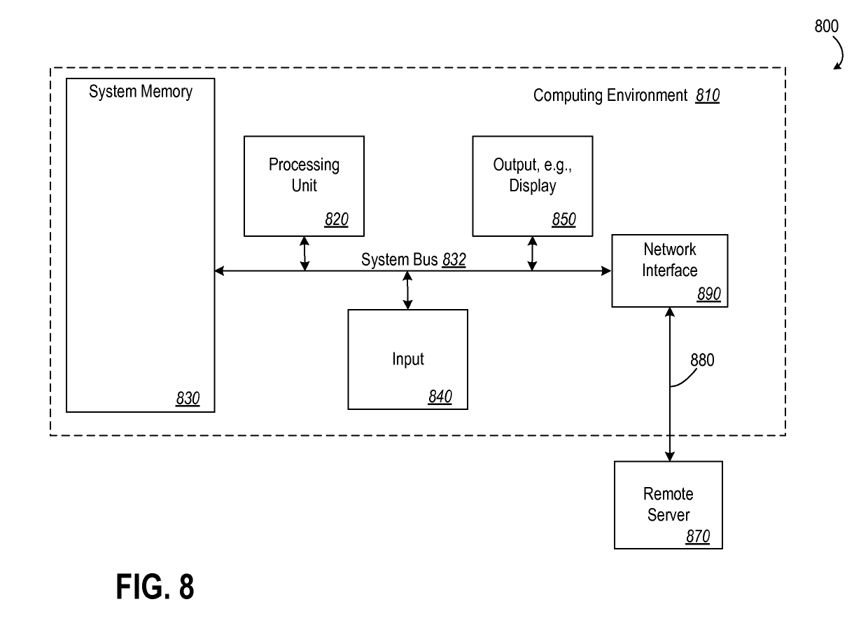

FIG. 8 thus illustrates an example of a suitable computing system environment 800 in which the claimed subject matter may be implemented, although as made clear above, the computing system environment 800 is only one example of a suitable computing environment for a mobile device and is not intended to suggest any limitation as to the scope of use or functionality of the claimed subject matter. Further, the computing environment 800 is not intended to suggest any dependency or requirement relating to the claimed subject matter and any one or combination of components illustrated in the example operating environment 800.

With reference to FIG. 8, an example of a remote device for implementing various aspects described herein includes a general purpose computing device in the form of a computer 810. Components of computer 810 can include, but are not limited to, a processing unit 820, a system memory 830, and a system bus 832 that couples various system components including the system memory to the processing unit 820. The system bus 832 can be any of several types of bus structures including a memory bus or memory controller, a peripheral bus, and a local bus using any of a variety of bus architectures.

Computer 810 can include a variety of computer readable media. Computer readable media can be any available media that can be accessed by computer 810. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media can embody computer readable instructions, data structures, program modules or other data in a modulated data signal such as a carrier wave or other transport mechanism and can include any suitable information delivery media.

The system memory 830 can include computer storage media in the form of volatile and/or nonvolatile memory such as read only memory (ROM) and/or random access memory (RAM). A basic input/output system (BIOS), containing the basic routines that help to transfer information between elements within computer 810, such as during start-up, can be stored in memory 830. Memory 830 can also contain data and/or program modules that are immediately accessible to and/or presently being operated on by processing unit 820. By way of non-limiting example, memory 830 can also include an operating system, application programs, other program modules, and program data.

The computer 810 can also include other removable/non-removable, volatile/nonvolatile computer storage media. For example, computer 810 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 832 through a non-removable memory interface such as an interface, and a magnetic disk drive or optical disk drive can be connected to the system bus 832 by a removable memory interface, such as an interface.

A user can enter commands and information into the computer 810 through input devices (not shown) such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 820 through user input 840 and associated interface(s) that are coupled to the system bus 832, but can be connected by other interface and bus structures, such as a parallel port, game port or a universal serial bus (USB). A graphics subsystem can also be connected to the system bus 832. In addition, a monitor or other type of display device can be connected to the system bus 832 via an interface, such as output interface 850, which can in turn communicate with video memory. In addition to a monitor, computers can also include other peripheral output devices, such as speakers and/or a printer, which can also be connected through output interface 850.

The computer 810 can operate in a networked or distributed environment using logical connections to one or more other remote computers, such as remote server 870, which can in turn have media capabilities different from device 810. The remote server 870 can be a personal computer, a server, a router, a network PC, a peer device or other common network node, and/or any other remote media consumption or transmission device, and can include any or all of the elements described above relative to the computer 810. The logical connections depicted in FIG. 8 include a network 880, such local area network (LAN) or a wide area network (WAN), but can also include other networks/buses. Such networking environments are commonplace in homes, offices, enterprise-wide computer networks, intranets and the Internet.

When used in a LAN networking environment, the computer 810 is connected to the LAN 880 through a network interface or adapter 890. When used in a WAN networking environment, the computer 810 can include a communications component, such as a modem, or other means for establishing communications over the WAN, such as the Internet. A communications component, such as a modem, which can be internal or external, can be connected to the system bus 832 via the user input interface at input 840 and/or other appropriate mechanism. In a networked environment, program modules depicted relative to the computer 810, or portions thereof, can be stored in a remote memory storage device. It should be appreciated that the network connections shown and described are exemplary and other means of establishing a communications link between the computers can be used.

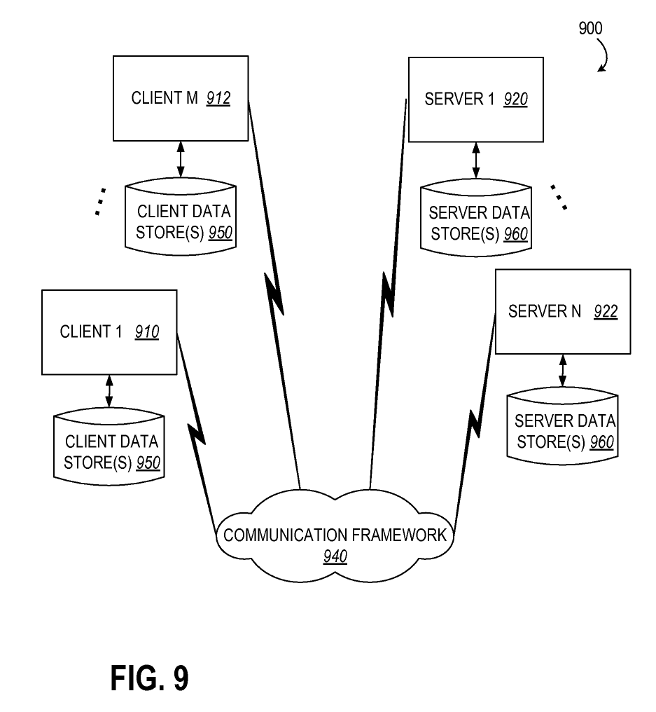

FIG. 9 is a schematic block diagram of a sample-computing environment 900 within which the disclosed and described components and methods can be used. The environment 900 includes one or more client(s) 910, 912. The client(s) 910, 912 can be hardware and/or software (e.g., threads, processes, computing devices). The environment 900 also includes one or more server(s) 920, 922. The server(s) 920, 922 can be hardware and/or software (for example, threads, processes, computing devices). The server(s) 920, 920 can house threads or processes to perform transformations by employing the disclosed and described components or methods, for example. Specifically, one component that can be implemented on the server 920, 922 is a security server. Additionally, various other disclosed and discussed components can be implemented on the server 920, 922.

One possible means of communication between a client 910, 912 and a server 920, 922 can be in the form of a data packet adapted to be transmitted between two or more computer processes. The environment 900 includes a communication framework 940 that can be employed to facilitate communications between the client(s) 910 and the server(s) 920. The client(s) 910, 912 are operably connected to one or more client data store(s) 950 that can be employed to store information local to the client(s) 910. Similarly, the server(s) 920, 922 are operably connected to one or more server data store(s) 960 that can be employed to store information local to the server(s) 920, 922.

The plurality of client systems 910, 912 can operate collaboratively based on their communicative connection. For instance, as described previously, a KPI guidance system 100 (FIG. 1) can transmit a defined solution model to a plurality of HMIs 110 (FIG. 1) to share the experience and knowledge of an operator with others. In another example, the KPI guidance systems 100 can operate in a series fashion, allowing an operators' communication received by KPI guidance client “1” 910, to the next client “2” (not shown), etc., to transmit the information to the next client “M” 912, which transmits the information to servers 920, 922.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various aspects described herein, it is to be understood that other similar aspects can be used or modifications and additions can be made to the described aspect(s) for performing the same or equivalent function of the corresponding aspect(s) without deviating there from. Still further, multiple processing chips or multiple devices can share the performance of one or more functions described herein, and similarly, storage can be effected across a plurality of devices. Accordingly, no single aspect shall be considered limiting, but rather the various aspects and their equivalents should be construed consistently with the breadth, spirit and scope in accordance with the appended claims.

While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

What is claimed is:

1. A method of generating dynamic context for an industrial process, comprising:
capturing context data from an industrial process;
receiving a request to perform a calculated value for the captured context data;
recognizing a context attribute by accessing a process category associated with the industrial process; and
generating the calculated value based upon the recognized context attribute.

2. The method of claim 1, further comprising:
capturing fixed context data from the industrial process; and
generating a key performance indicator (KPIs) visualization based upon the captured fixed content data.

3. The method of claim 1, further comprising enabling a client application from a remote network to generate the calculated value with a subscription component.

4. The method of claim 3, further comprising enabling a base subscription level for a predetermined number of dynamic context calculations and enabling a premium subscription for an additional number of dynamic context calculations.

5. The method of claim 4, further comprising enabling display of captured display without calculations as part of the base subscription.

6. The method of claim 1, further comprising:
synchronizing data capture across a plurality of process entities; and
analyzing captured data for time dependencies.

7. The method of claim 6, further comprising analyzing capture data for time dependencies selected from a group consisting of day of week, shift, and time of day.

8. The method of claim 1, further comprising:
determining a varying ambient conditions for an industrial process; and
analyzing captured data for a variance in context as a function of a differing ambient condition.

9. The method of claim 1, further comprising:
determining an ambient condition for a plurality of sites of an industrial process; and
analyzing captured data for a variance in context between sites as a function of a differing ambient condition.

10. The method of claim 1, further comprising interfacing to a plurality of process entities within the industrial process.

11. The method of claim 10, further comprising interfacing to a data historian, a manufacturing execution system, and an ambient condition sensor.

12. The method of claim 1, further comprising interfacing to a plurality of sites of the industrial process via a public network.

13. At least one processor for generating dynamic context for an industrial process, comprising:
a first module for accessing context data from an industrial process;
a second module for generating a key performance indicator visualization for a subset of fixed context data of the accessed context data;
a third module for receiving a request for a calculated tag based on a subset of flexible context data of the accessed context data; and
a fourth module for generating the requested calculated tag.

14. An apparatus for generating dynamic context for an industrial process, comprising:
a data capture component for capturing context data from an industrial process;
a human-machine interface (HMI) for receiving a request to perform a calculated value for the captured context data; and
a dynamic context analyzer for recognizing a context attribute by accessing a process category associated with the industrial process, and for generating the calculated value based upon the recognized context attribute.

15. The apparatus of claim 14, further comprising:
the data capture component for capturing fixed context data from the industrial process; and
the dynamic context analyzer for generating a key performance indicator (KPIs) visualization based upon the captured fixed content data.

16. The apparatus of claim 14, further comprising a subscription component for enabling the dynamic context analyzer to generate the calculated value.

17. The apparatus of claim 16, further comprising the subscription component for enabling a base subscription level for a predetermined number of dynamic context calculations and for enabling a premium subscription for an additional number of dynamic context calculations.

18. The apparatus of claim 14, further comprising:
the data capture for synchronizing data capture across a plurality of process entities; and
the dynamic context analyzer for analyzing captured data for time dependencies selected from a group consisting of day of week, shift, and time of day.

19. The apparatus of claim 14, further comprising:
the data capture component for determining a varying ambient conditions for an industrial process; and
the dynamic context analyzer for analyzing captured data for a variance in context as a function of a differing ambient condition across a selected one of different locations and different time frames for the same location.

20. The apparatus of claim 14, further comprising interfacing to a plurality of process entities within the industrial process comprising a data historian, a manufacturing execution system, a public network and an ambient condition sensor.
